(19) United States
(12) Patent Application Publication
(10) Pub. No.: US 2022/0223888 A1
(43) Pub. Date: Jul. 14, 2022

(54) FUEL CELL SYSTEM AND OPERATING METHOD

(71) Applicants: FUJI ELECTRIC CO., LTD., Kawasaki-shi (JP); MITSUBISHI POWER, LTD., Yokohama-shi (JP)

(72) Inventors: Kouhei MURAKAMI, Kawasaki-shi (JP); Kuniyuki TAKAHASHI, Kawasaki-shi (JP)

(73) Assignees: FUJI ELECTRIC CO., LTD., Kawasaki-shi (JP); MITSUBISHI POWER, LTD., Yokohama-shi (JP)

(21) Appl. No.: 17/709,582

(22) Filed: Mar. 31, 2022

Related U.S. Application Data
(63) Continuation of application No. PCT/JP2020/044499, filed on Nov. 30, 2020.

(30) Foreign Application Priority Data
Dec. 25, 2019 (JP) 2019-234465

(51) Int. Cl. H01M 8/04303; H01M 8/04014; H01M 8/04119; H01M 8/04828; H01M 8/04228; H01M 8/04082; H01M 8/04701

(52) U.S. Cl. CPC H01M 8/04303; H01M 8/04014; H01M 8/04126; H01M 2008/1293; H01M 8/04228; H01M 8/04201; H01M 8/04738; H01M 8/04835

(57) ABSTRACT

A fuel cell system includes an anode gas flow channel, a cathode gas flow channel, a solid oxide fuel cell to which a fuel gas from the anode gas flow channel and an air from the cathode gas flow channel are supplied to generate electricity through an electrochemical reaction between the fuel gas and the air, and a steam generator that generates a steam to be mixed with the fuel gas upon an operation of the solid oxide fuel cell being stopped. The steam generator is disposed such that heat is exchangeable between the steam generator and the fuel gas flowing through the anode gas flow channel or between the steam generator and the air flowing through the cathode gas flow channel.

### CROSS REFERENCE TO RELATED APPLICATIONS

This is a continuation application of International Application PCT/JP2020/044499 filed on Nov. 30, 2020 which claims priority from a Japanese Patent Application No. 2019-234465 filed on Dec. 25, 2019, the contents of which are incorporated herein by reference.

### BACKGROUND OF THE INVENTION

### Technical Field

The present invention relates to a fuel cell system and an operating method.

### Background Art

In the invention described in Patent Literature 1, when a solid oxide fuel cell stops, steam is generated by heating a water vaporizer with a ceramic heater to reform a fuel gas.

### CITATION LIST

### Patent Literature

Patent Literature 1: Japanese Patent Laid-Open No. 2011-119055

### SUMMARY OF INVENTION

### Technical Problem

However, in the invention described in Patent Literature 1, it takes time for the heat from the heater to raise the temperature of the water vaporizer enough for the water vaporizer to reach a temperature at which steam can be generated. For this reason, the steam is generated after a delay from the stopping of the solid oxide fuel cell. Consequently, after the solid oxide fuel cell stops, there is time in which the steam is not supplied, and during this time, the fuel gas is still supplied to the fuel cell stack. According to this configuration, the steam to carbon ratio (S/C) is lowered, carbon is deposited on the catalyst in the reformer and the fuel cell stack, and the catalyst is degraded in a phenomenon also referred to as coking.

An object of the present invention, which has been made in the light of such problems, is to provide a fuel cell system and an operating method capable of generating steam immediately after the solid oxide fuel cell stops.

### Solution to Problem

A fuel cell system according to one aspect of the present invention comprises an anode gas flow channel, a cathode gas flow channel, a solid oxide fuel cell which is supplied with a fuel gas from the anode gas flow channel and air from the cathode gas flow channel to generate electricity through an electrochemical reaction, and a steam generator that generates steam to be mixed with the fuel gas when the solid oxide fuel cell stops, wherein the steam generator is disposed such that heat is exchangeable with a gas flowing through the anode gas flow channel or the cathode gas flow channel.

An operating method of a fuel cell system according to another aspect of the present invention is an operating method of a fuel cell system that mixes steam with a fuel gas when a solid oxide fuel cell, which is supplied with the fuel gas from an anode gas flow channel and air from a cathode gas flow channel to generate electricity through an electrochemical reaction, stops, the operating method comprising disposing a steam generator such that heat is exchangeable with a gas flowing through the anode gas flow channel or the cathode gas flow channel, and maintaining the steam generator at a temperature sufficient for generating steam through heat exchange with the gas while the solid oxide fuel cell is generating electricity, and causing the steam generator to generate the steam when the solid oxide fuel cell stops generating electricity.

### Advantageous Effects of Invention

According to the present invention, steam can be generated immediately after the solid oxide fuel cell stops. Consequently, it is possible to reduce the time in which steam is not supplied after the solid oxide fuel cell stops, and thereby prevent degradation of the catalyst in the reformer and the fuel cell stack.

### BRIEF DESCRIPTION OF DRAWINGS

FIG. 1 is a conceptual diagram of a fuel cell system according to a first embodiment of the present invention.

FIG. 2 is a perspective view of a steam generator according to the present embodiment.

FIG. 3 is a schematic cross section illustrating the steam generator and a gas flow channel.

FIG. 4 illustrates a temperature profile from power generation to stopping in the solid oxide fuel cell in a comparative example in which the steam generator does not contact the gas flow channel.

FIG. 5 illustrates a temperature profile from startup to power generation and stopping in the solid oxide fuel cell in the present embodiment in which the steam generator contacts the gas flow channel.

FIG. 6 is a graph illustrating an example of an operating method when the solid oxide fuel cell stops in a fuel cell system according to the present embodiment.

FIG. 7 is a conceptual diagram of a fuel cell system according to a second embodiment.

FIG. 8 is a conceptual diagram of a fuel cell system according to a third embodiment.

FIG. 9 is a conceptual diagram of a fuel cell system according to a fourth embodiment.

FIG. 10 illustrates a cross section of a gas flow channel having a steam generation function.

### DESCRIPTION OF EMBODIMENTS

Hereinafter, embodiments of the present invention will be described in detail. However, the present invention is not limited to the following embodiments, and may also be modified in various ways while remaining within the scope of the present invention.

### First Embodiment

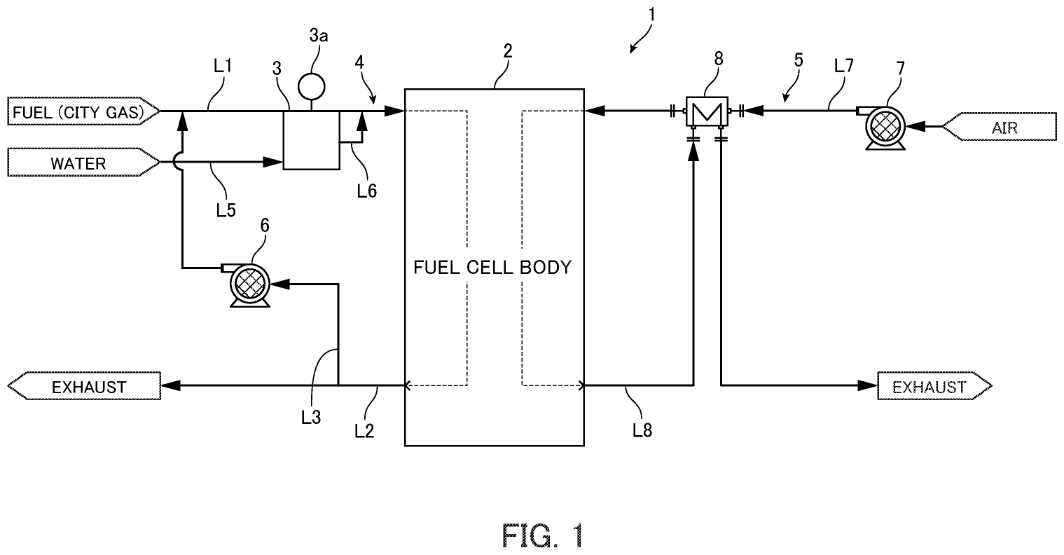

FIG. 1 is a conceptual diagram of a fuel cell system according to a first embodiment of the present invention. As illustrated in FIG. 1, a fuel cell system 1 includes a solid oxide fuel cell (SOFC) 2, a steam generator 3, an anode gas flow channel 4, and a cathode gas flow channel 5. Note that the anode gas flow channel 4 and the cathode gas flow channel 5 may be referred to as the “gas flow channel(s)” when not being distinguished individually.

The solid oxide fuel cell 2 includes a cell stack configured as a layering or a collection of a plurality of cells. Each cell has a basic configuration in which an electrolyte is disposed between an air electrode and a fuel electrode, and a separator is interposed between the cells. The cells of the cell stack are electrically connected in series. The solid oxide fuel cell is a power generation mechanism in which electrical energy is generated by causing oxide ions generated by an air electrode to pass through an electrolyte and move to a fuel electrode, such that the oxide ions react with hydrogen or carbon monoxide at the fuel electrode.

The anode gas flow channel 4 includes an anode gas inlet channel L1 on the inlet side from the perspective of the solid oxide fuel cell 2 and an anode gas outlet channel L2 on the outlet side from the perspective of the solid oxide fuel cell 2.

The anode gas inlet channel L1 functions as a fuel gas supply channel that supplies a fuel gas to the solid oxide fuel cell 2. The flow rate of the fuel gas is adjusted by a fuel supply blower not illustrated. The anode gas outlet channel L2 functions as an exhaust channel that releases an anode exhaust gas. Also, the anode gas outlet channel L2 is provided with a recirculation channel L3 that branches off partway through and recirculates the anode exhaust gas to the anode gas inlet channel L1. As illustrated in FIG. 1, a recirculation blower 6 is provided in the recirculation channel L3 to adjust the flow rate of the recirculated anode exhaust gas.

In the first embodiment illustrated in FIG. 1, the steam generator 3 is disposed so as to allow heat exchange with the fuel gas flowing through the anode gas inlet channel L1. The steam generator 3 is disposed on the portion of the anode gas inlet channel L1 between the solid oxide fuel cell 2 and the recirculation channel L3, for example. As illustrated in FIG. 1, a water supply channel L5 is provided on the inlet side of the steam generator 3. Also, a steam supply channel L6 is provided on the outlet side of the steam generator 3, and steam generated by the steam generator 3 passes through the steam supply channel L6 and is mixed with the fuel gas flowing through the anode gas inlet channel L1.

As illustrated in FIG. 1, the cathode gas flow channel 5 includes a cathode gas inlet channel L7 on the inlet side from the perspective of the solid oxide fuel cell 2 and a cathode gas outlet channel L8 on the outlet side from the perspective of the solid oxide fuel cell 2.

Air is supplied to the solid oxide fuel cell 2 from the cathode gas inlet channel L7 by an air blower 7. A regenerative heat exchanger 8 is provided in the cathode gas inlet channel L7.

As illustrated in FIG. 1, the cathode gas outlet channel L8 that acts as an exhaust channel for the cathode exhaust gas is connected to the regenerative heat exchanger 8 to form a flow channel that recirculates the cathode exhaust gas. In the regenerative heat exchanger 8, the air flowing through the cathode gas inlet channel L7 exchanges heat with the cathode exhaust gas, and the temperature rises.

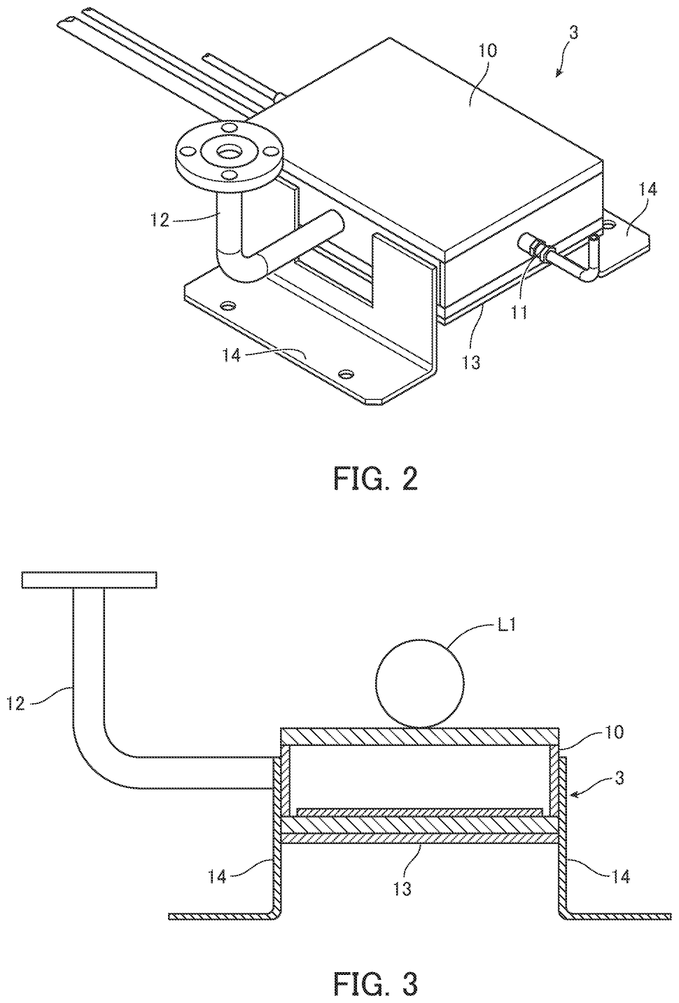

The steam generator 3 will be described. As illustrated in FIGS. 2 and 3, the steam generator 3 includes a housing 10, a tubular part 11 provided on the front surface (the surface facing the inlet side) of the housing 10, a steam release pipe 12 provided on a side surface of the housing 10, a heater 13 disposed on the underside of the housing 10, and a fixture 14 for affixing the steam generator 3 to a predetermined location in the fuel cell system 1. The arrangement of the tubular part 11 and the steam release pipe 12 may also be different from FIG. 2.

The tubular part 11 and the steam release pipe 12 lead into the housing 10. The tubular part 11 is connected to the water supply channel L5 illustrated in FIG. 1. The steam release pipe 12 forms all or part of the steam supply channel L6 illustrated in FIG. 1. In the case where the steam release pipe 12 forms all of the steam supply channel L6, the steam release pipe 12 is connected directly to the anode gas inlet channel L1.

As illustrated in FIG. 3, the steam generator 3 contacts the anode gas inlet channel L1. For this reason, the steam generator 3 is capable of exchanging heat with the fuel gas flowing through the anode gas inlet channel L1, and is kept in a high-temperature state (at or above 300° C., for example). Note that the temperature of the steam generator 3 is measured by a temperature measuring instrument 3a (see FIG. 1).

Consequently, when water is supplied to the steam generator 3 through the water supply channel L5, steam can be generated immediately, and the steam can be supplied from the steam release pipe 12 to the fuel gas flowing through the anode gas inlet channel L1.

As illustrated in FIG. 3, the heater 13 is disposed out of contact with the anode gas inlet channel L1. If the heater 13 is made to contact the anode gas inlet channel L1 directly, thermal shock is imparted due to sudden gas temperature changes and the like, which leads to damage to the heater 13. Consequently, the heater 13 preferably is disposed so as not to contact the anode gas inlet channel L1, and may also be disposed somewhere other than the underside of the housing 10.

The heater 13 has a role of providing assistive heating to keep the steam generator 3 at a high temperature.

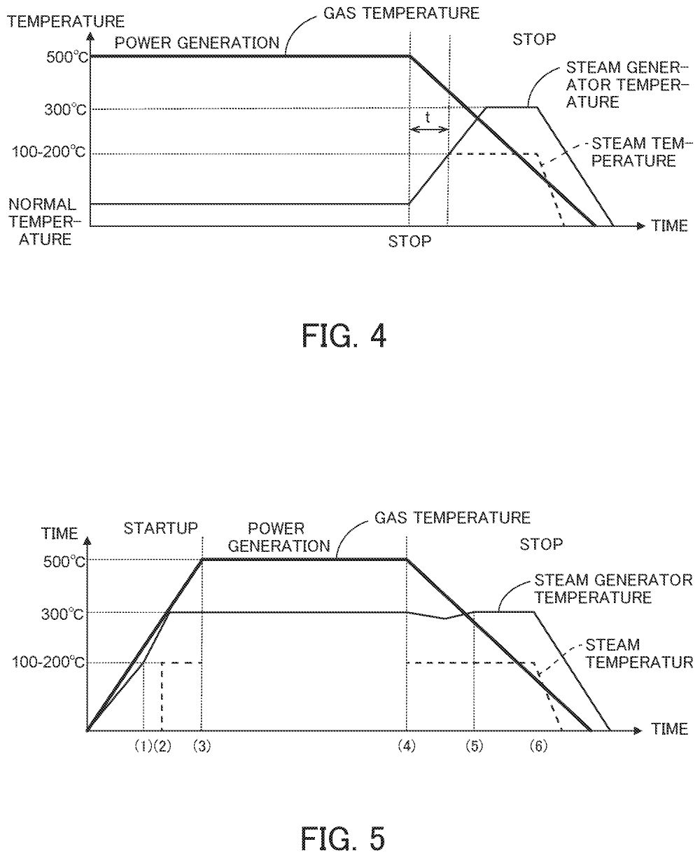

Hereinafter, FIGS. 4 and 5 will be used to describe temperature profiles from power generation to stopping in the solid oxide fuel cell according to a comparative example and the present embodiment.

FIG. 4 is the temperature profile of the comparative example. In the comparative example, unlike the present embodiment, the steam generator 3 does not contact the anode gas inlet channel L1.

As illustrated in FIG. 4, while the solid oxide fuel cell 2 is generating electricity, the steam generator 3 is not exchanging heat with the fuel gas flowing through the anode gas inlet channel L1 and remains at a normal temperature. As illustrated in FIG. 4, when the solid oxide fuel cell 2 stops generating electricity, the heater 13 of the steam generator 3 is activated to raise the temperature of the steam generator 3. The temperature of the steam generator 3 is ultimately raised to approximately 300° C. As illustrated in FIG. 4, water is supplied to the steam generator 3, and if the temperature of the steam generator 3 is at or above 100° C. at this time, steam begins to form. However, as illustrated in FIG. 4, the generation of the steam is delayed by a time t from when the solid oxide fuel cell 2 stopped.

On the other hand, FIG. 5 is the temperature profile of the present embodiment. In the present embodiment, as illustrated in FIGS. 1 and 3, the steam generator 3 is made to contact the anode gas inlet channel L1. Note that FIG. 5 is used to describe a temperature profile from startup to power generation and stopping in the solid oxide fuel cell 2.

As illustrated in FIG. 5, from the startup of the solid oxide fuel cell 2 until a time (1), the temperature of the steam generator 3 rises due to the transfer of heat from the fuel gas. During the period between the time (1) and a time (2), the heater 13 provided in the steam generator 3 is activated to further raise the temperature of the steam generator 3. In this way, the temperature of the steam generator is raised to approximately 300° C. by the transfer of heat from the fuel gas and by heating provided by the heater.

As illustrated in FIG. 5, when the time (2) is reached, steam is generated and mixed with the fuel gas. With this arrangement, steam reforming of the fuel gas can be performed.

While the solid oxide fuel cell 2 is generating electricity (from a time (3) to a time (4) illustrated in FIG. 5), the supply of steam is stopped to achieve water self-reliance. As illustrated in FIG. 5, while the solid oxide fuel cell 2 is generating electricity, the steam generator 3 can be kept at approximately 300° C. (hot standby) through the transfer of heat from the fuel gas.

At the time (4), the solid oxide fuel cell 2 stops generating electricity, and at the same time, water is supplied to the steam generator 3. At this time, because the steam generator 3 is maintained at a temperature of approximately 300° C., steam can be generated immediately after the water is supplied.

As illustrated in FIG. 5, during the period from the time (4) to a time (5), the temperature of the steam generator 3 falls briefly due to the generation of steam, but by activating the heater 13, the steam generator 3 can be brought back and kept to a temperature of approximately 300° C. through heating provided by the heater.

As illustrated in FIG. 5, the gas temperature continues to fall from the time (4) when the solid oxide fuel cell 2 stops generating electricity. In the period from the time (5) to a time (6), due to the falling of the gas temperature, steam is generated by heating the steam generator 3 mainly with heating provided by the heater.

As illustrated in the temperature profile according to the present embodiment illustrated in FIG. 5, unlike the comparative example in FIG. 4, steam can be generated once the solid oxide fuel cell 2 stops. As a result, the degradation of the catalyst in the reformer and the fuel cell stack can be suppressed after the solid oxide fuel cell 2 stops, and coking can be prevented effectively.

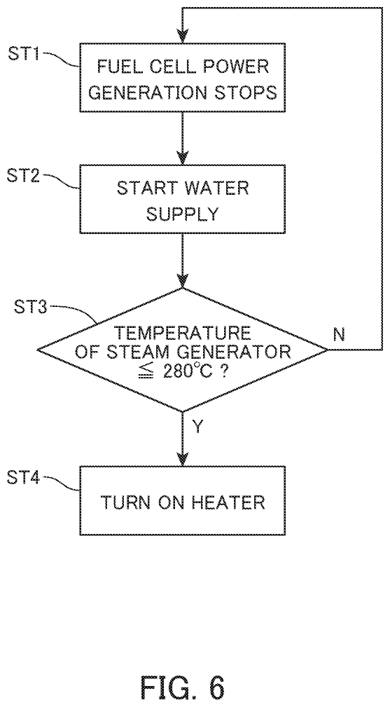

FIG. 6 is a graph illustrating an example of an operating method when a stop occurs in the fuel cell system according to the present embodiment.

In step ST1, the solid oxide fuel cell 2 stops generating electricity (time (4) in FIG. 5). Next, in step ST2, water is supplied to the steam generator 3. At this time, the steam generator 3 is being maintained at a temperature sufficient for generating steam, and therefore steam can be generated by the steam generator 3 immediately by supplying the water.

In step ST3, the temperature of the steam generator 3 is measured by the temperature measuring instrument 3a (see FIG. 1), and when the temperature of the steam generator 3 falls below 280° C. as illustrated in the period from the time (4) to the time (5) in FIG. 5, for example, the flow proceeds to step ST4. Additionally, the heater 13 attached to the steam generator 3 is activated. With this arrangement, the temperature of the steam generator 3 can be raised back up to 300° C.

As above, the steam generator 3 is maintained at a temperature sufficient for generating steam, and therefore the steam generator 3 can generate steam immediately after the solid oxide fuel cell 2 stops generating electricity. When a certain time elapses from the stopping of the solid oxide fuel cell 2, the temperature of the steam generator 3 begins to fall. Consequently, heating provided by the heater 13 is used to keep the steam generator 3 at a predetermined temperature, thereby making it possible to continue generating steam for a certain time for clearing up coking immediately after the solid oxide fuel cell 2 stops.

In the first embodiment illustrated in FIG. 1, the steam generator 3 is disposed on the anode gas inlet channel L1 of the anode gas flow channel 4. With this arrangement, the steam supply channel L6 can be shortened, the stream can be mixed with the fuel gas immediately after the solid oxide fuel cell 2 stops, and coking can be prevented effectively.

In this way, in the present embodiment, the steam generator 3 preferably is disposed on the anode gas inlet channel L1 of the anode gas flow channel 4, but the steam generator 3 is not limited thereto and may also be disposed at another location in a gas flow channel. Hereinafter, examples of disposing the steam generator 3 at a different location from FIG. 1 will be described.

### OTHER EMBODIMENTS

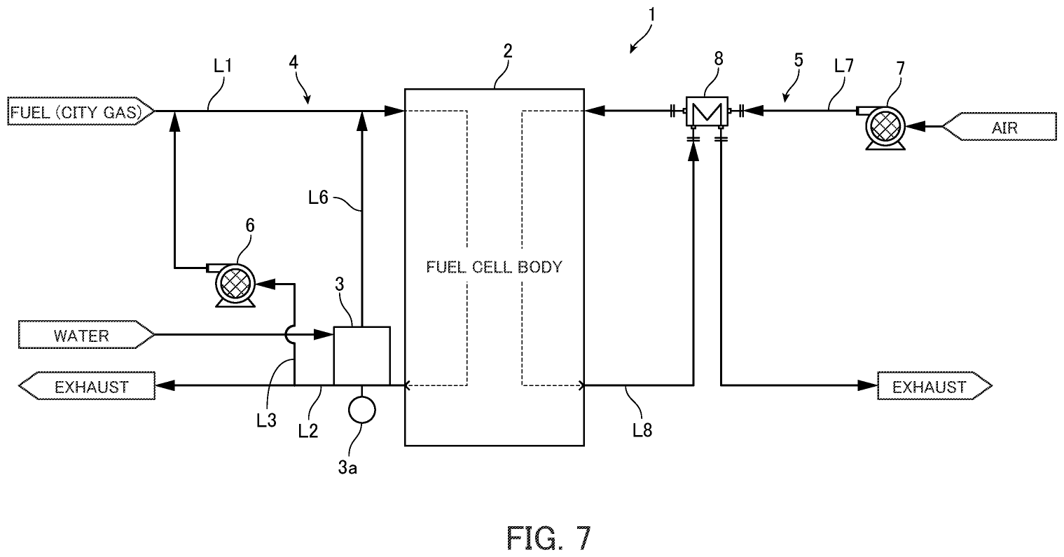

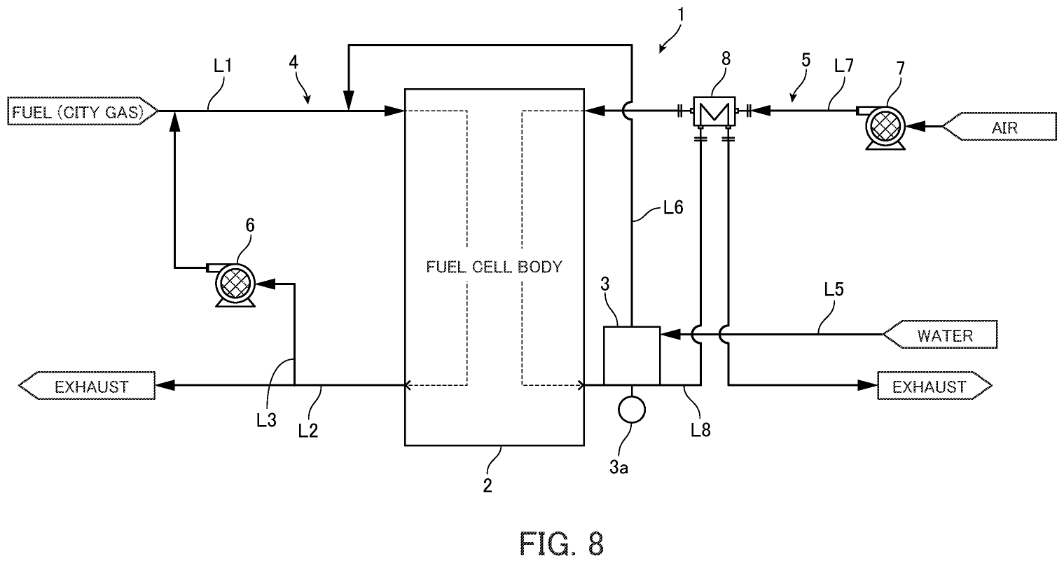

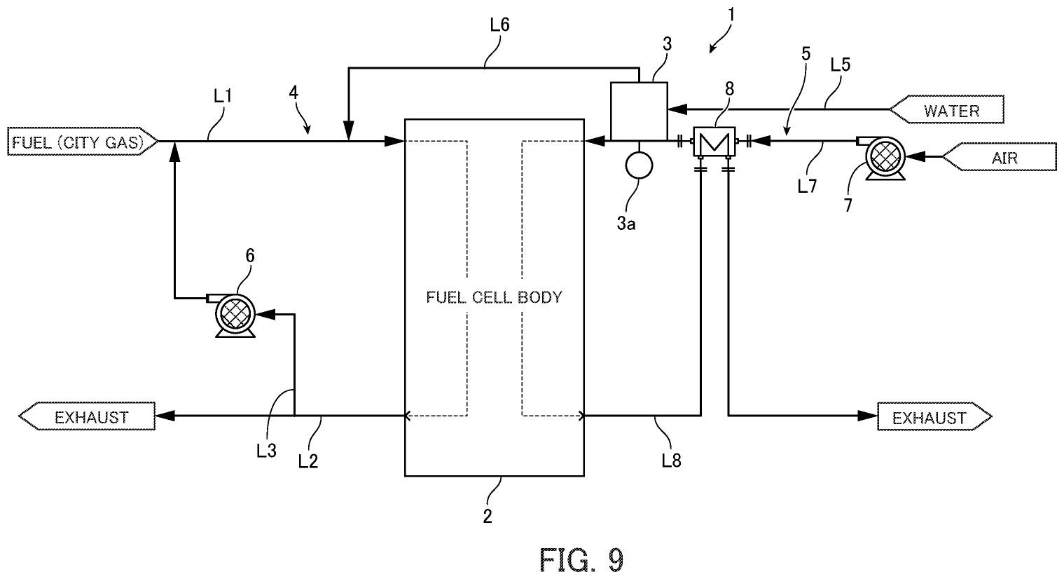

FIG. 7 is a conceptual diagram of a fuel cell system according to a second embodiment, FIG. 8 is a conceptual diagram of a fuel cell system according to a third embodiment, and FIG. 9 is a conceptual diagram of a fuel cell system according to a fourth embodiment.

In the embodiments in FIGS. 7 to 9, signs that are the same as in FIG. 1 denote the same portions. In the second embodiment illustrated in FIG. 7, the steam generator 3 is disposed on the anode gas outlet channel L2 on the outlet side of the anode gas flow channel 4. By causing the steam generator 3 to contact the anode gas outlet channel L2, similarly to FIG. 3, heat can be exchanged effectively with the exhaust gas flowing through the anode gas outlet channel L2. Note that the steam generator 3 may also be disposed in contact with the recirculation channel L3.

In the third embodiment illustrated in FIG. 8, the steam generator 3 is disposed on the cathode gas outlet channel L8 on the outlet side of the cathode gas flow channel 5. By causing the steam generator 3 to contact the cathode gas outlet channel L8, similarly to FIG. 3, heat can be exchanged effectively with the exhaust gas flowing through the cathode gas outlet channel L8. Preferably, the steam generator 3 is disposed in contact with the recirculation channel of the cathode gas outlet channel L8.

In the fourth embodiment illustrated in FIG. 9, the steam generator 3 is disposed on the cathode gas inlet channel L7 on the inlet side of the cathode gas flow channel 5. By causing the steam generator 3 to contact the cathode gas inlet channel L7, similarly to FIG. 3, heat can be exchanged effectively with the oxidant gas flowing through the cathode gas inlet channel L7.

Additionally, in the embodiments in FIGS. 7 to 9, when the solid oxide fuel cell 2 stops, steam can be generated by supplying water to the steam generator 3. By passing the steam through the steam supply channel L6 to mix with the fuel gas flowing through the anode gas inlet channel L1, steam reforming of the fuel gas can be performed immediately after the solid oxide fuel cell 2 stops. With this arrangement, degradation of the catalyst in the reformer and the fuel cell stack can be suppressed, and coking can be prevented effectively.

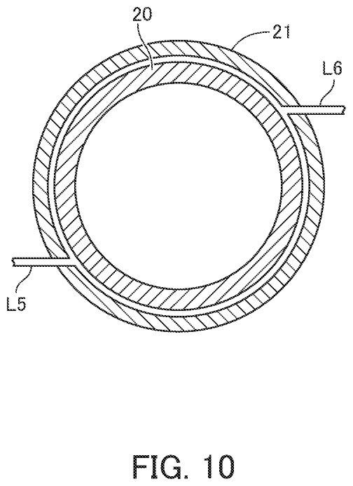

Also, as illustrated in FIG. 10, the steam generator according to the embodiments may also be integrated with a portion of a gas flow channel. In FIG. 10, the gas flow channel has a double-walled pipe structure with a heater layer 21 provided on the outer circumference of a pipe 20. A space allowing the passage of water from the water supply channel L5 is provided between the heater layer 21 and the pipe 20. With this arrangement, steam can be generated by heat exchange with a gas flowing inside the pipe 20. The space between the heater layer 21 and the pipe 20 leads to the steam supply channel L6 at a location different from the water supply channel L5. In addition, through the steam supply channel L6, the steam is mixed with the fuel gas flowing through the anode gas inlet channel L1. In this way, by configuring the gas flow channel as a double-walled pipe structure, the gas flow channel itself can be given a steam generation function with a high heat exchange ratio, making it possible to supply steam efficiently. Moreover, it is possible to provide a stable supply of steam even with a heater of low capacity.

Note that although embodiments of the present invention have been described, the above embodiments and modifications thereof may also be combined in full or in part and treated as another embodiment of the present invention.

Also, embodiments of the present invention are not limited to the embodiments described above, and various modifications, substitutions, and alterations are possible without departing from the scope of the technical idea according to the present invention. Further, if the technical idea according to the present invention can be achieved according to another method through the advancement of the technology or another derivative technology, the technical idea may be implemented using the method. Consequently, the claims cover all embodiments which may be included in the scope of the technical idea according to the present invention.

For example, the embodiments may also have a structure in which the heater 13 is not provided in the steam generator 3. In this case, when the temperature of the steam generator 3 falls as illustrated during the period between the time (4) and the time (5) in FIG. 5, steam can be generated for a longer time by controlling factors such as reducing the quantity of steam to be supplied. However, by providing the heater 13 as an external power source in the steam generator 3, when the temperature of the steam generator 3 falls, heating can be provided by the heater 13 to keep the temperature of the steam generator 3 at a certain value, making it possible to supply a fixed quantity of steam continually. With this arrangement, a high S/C can be maintained and the risk of fuel cell degradation can be reduced.

Also, in the above embodiments, the steam generator 3 is made to contact a gas flow channel, but the steam generator 3 does not have to contact the gas flow channel insofar heat exchange is possible with the gas flowing through the gas flow channel. For example, an intermediate layer may exist between the steam generator 3 and the gas flow channel, or alternatively, some space may be provided between the steam generator 3 and the gas flow channel.

This application is based on Japanese Patent Application No. 2019-234465 filed on Dec. 25, 2019, the content of which is hereby incorporated in entirety.

What is claimed is:

1. A fuel cell system, comprising:
an anode gas flow channel;
a cathode gas flow channel;
a solid oxide fuel cell to which a fuel gas from the anode gas flow channel and an air from the cathode gas flow channel are supplied to generate electricity through an electrochemical reaction between the fuel gas and the air; and
a steam generator that generates a steam to be mixed with the fuel gas upon an operation of the solid oxide fuel cell being stopped, wherein
the steam generator is disposed such that heat is exchangeable between the steam generator and the fuel gas flowing through the anode gas flow channel or between the steam generator and the air flowing through the cathode gas flow channel.

2. The fuel cell system according to claim 1, wherein
the anode gas flow channel has an inlet and an outlet, and
the steam generator is disposed at an inlet side of the anode gas flow channel.

3. The fuel cell system according to claim 1, further comprising a heater that suppresses a temperature drop of the steam generator after the operation of the solid oxide fuel cell is stopped.

4. An operating method of a fuel cell system having an anode gas flow channel and a cathode gas flow channel through which respectively a fuel gas and an air are supplied to a solid oxide fuel cell to generate electricity through an electrochemical reaction between the fuel gas and the air, the operating method comprising:
disposing a steam generator such that heat is exchangeable between the steam generator and the fuel gas flowing through the anode gas flow channel or between the steam generator and the air flowing through the cathode gas flow channel; and
maintaining the steam generator at a temperature sufficient for generating a steam through heat exchange with the fuel gas or the air while the solid oxide fuel cell is generating electricity, thereby generating the steam by the steam generator upon an operation of the solid oxide fuel cell being stopped.

5. The operating method of a fuel cell system according to claim 4, further comprising:
heating the steam generator with a heater to suppress a temperature drop of the steam generator after the operation of the solid oxide fuel cell is stopped.
